(19) United States
(12) Patent Application Publication
(10) Pub. No.: US 2009/0038645 A1
(43) Pub. Date: Feb. 12, 2009

(54) Cleaning apparatus, cleaning tank, cleaning method and computer-readable storage medium

(75) Inventors: Michinao Nomura, Kawasaki (JP); Yoshiaki Yanagida, Kawasaki (JP); Koji Sudo, Kawasaki (JP); Shusuke Kobayashi, Tochigi (JP); Toshiharu Shibano, Tochigi (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); FUJITSU AUTOMATION LIMITED, Kawasaki (JP)

(21) Appl. No.: 12/219,445

(22) Filed: Jul. 22, 2008

(30) Foreign Application Priority Data
Aug. 6, 2007 (JP) 2007-204797

(51) Int. Cl. B08B 7/04; B08B 13/00

(52) U.S. Cl. 134/18; 134/56 R

(57) ABSTRACT

The cleaning apparatus for cleaning a cleaning target set in a cleaning tank filled with a washing fluid includes a flow-control unit for generating a predetermined flow of the washing fluid in the cleaning tank; and an ejection unit for ejecting the washing fluid disposed on a flow path of the predetermined flow of the washing fluid. The cleaning apparatus ejects the washing fluid to outside the cleaning tank by using the ejection unit in removing contaminants on a surface of the cleaning target by washing the cleaning target with the washing fluid. Also, a cleaning tank having substantially the same structure as that of the cleaning apparatus is provided. Moreover, a cleaning method implemented using the cleaning apparatus as described above or the like is provided.

Under provisions of 35 U.S.C. §119(e), Applicant claims the benefit of Japanese Patent Application No. 2007-204797 filed on Aug. 6, 2007, which is incorporated herein by reference.

### BACKGROUND OF THE INVENTION

1. Field of the Invention

The present invention relates to a cleaning apparatus, a cleaning tank, a cleaning method, and a computer-readable storage medium with a cleaning-control program stored therein, which are directed to cleaning a cleaning target by using a washing fluid thereby to remove contaminants on a surface of a cleaning target (e.g., various types of devices) set in a cleaning tank filled with the washing fluid.

More specifically, the invention is intended to provide a technique which can achieve a high quality of cleaning in washing various types of devices put in a cleaning tank by means of a washing fluid in a process to fabricate various types of devices including small-size devices, such as magnetic heads of HDDs (HDD: Hard Disk Drive), MEMS (Micro Electro Mechanical Systems: systems having miniaturized electronic circuits incorporated therein together with mechanical components), and optical parts (mirrors and lenses), and such technique will be described here.

2. Description of the Related Art

In recent years, it has been becoming requisite to carry out precise cleaning for removing contaminants of a submicron scale (0.5 micrometers in diameter) or larger, which are produced during fabrication processes, as the request for accuracy of small-size devices, such as magnetic heads of HDDs, MEMS, and optical parts, and the request for miniaturization of the above small-size devices, have been increased. One of conventional cleaning methods for carrying out precise cleaning of small-size devices is disclosed by Japanese Laid-open Patent Publication No. 6-55151, which will be mentioned later as Patent Document 1. The conventional cleaning method will be described here.

In the conventional cleaning method, a cleaning target, such as a small-size device, is immersed in a washing liquid (or washing fluid) in a cleaning tank, and in this condition, ultrasonic waves are applied to the washing liquid by using an ultrasonic vibrator. A contaminant (or contamination) on a surface of a cleaning target is peeled off through a cavitation phenomenon. The washing liquid is supplied into the cleaning tank through a supply hole constantly, and the contaminant peeled off from the cleaning target is carried by the washing liquid flowing over the top face of the cleaning tank, and ejected to outside the tank together with the washing liquid.

However, such conventional cleaning method causes the problem in that a washing liquid accumulates e.g., in vicinities of cleaning targets, and corner portions of a cleaning tank, which prevents the contaminants from being ejected, and increases the quantity of contaminants in the washing liquid and therefore deteriorates the cleanliness of the washing liquid. As a result of deterioration in the cleanliness of the washing liquid in the cleaning tank, contaminants peeled off from cleaning targets will adhere to the surfaces of the cleaning targets again, degrading the quality of cleaning when the cleaning targets, such as small-size devices, are retrieved from inside the cleaning tank.

Now, as prior art documents associated with the conventional cleaning method as described above, Patent Documents 1 to 4 that will be described later are presented for reference.

Patent Document 1 (Japanese Laid-open Patent Publication No. 6-55151) discloses a technique associated with a method for cleaning a cleaning target such as a small-size device by using cleaning apparatus including a cleaning tank which stores a washing liquid and has an ultrasonic vibrator incorporated in a lower portion thereof; a nozzle which causes a flow of the washing liquid in the cleaning tank; an overflow tank which accepts the washing liquid having overflowed the cleaning tank; an oil-separation tank for holding the washing liquid having flowed out from the overflow tank; an oil-content overflow tank which accepts an oil content having overflowed the oil-separation tank; and a circulating pump which returns the washing liquid with its oil content removed in the oil-separation tank into the cleaning tank.

However, according to the technique described in Patent Document 1, the washing liquid accumulates e.g., in the vicinity of a cleaning target or corners of the cleaning tank and no contaminant is ejected as described above. As a result, the quantity of contaminants in the washing liquid is increased and the cleanliness of the washing liquid is deteriorated. Hence, contaminants peeled off from the cleaning targets adhere to surfaces of the cleaning targets again, degrading the quality of cleaning when the cleaning target is retrieved from the cleaning tank.

Patent Document 2 (Japanese Laid-open Patent Publication No. 2006-231185) discloses a technique associated with a cleaning method including supplying pollutive substances with liquid drops, applying ultrasonic waves to the liquid drops by using an ultrasonic horn to take off the pollutive substances from cleaning targets, and removing the pollutive substances thus taken off together with the liquid drops by suction.

However, unlike the present invention, with regard to the technique disclosed by Patent Document 2, there is no description therein about forming a predetermined flow in the washing fluid in the cleaning tank by using a flow-control means. Therefore, the technique associated with Patent Document 2 cannot cope with the problem that the increase in the quantity of the pollutive substances deteriorates the cleanliness of the washing fluid because when there is a large quantity of pollutive substances to be removed, the washing fluid accumulates e.g., in vicinities of cleaning targets and corners of the cleaning tank, which prevents the pollutive substances from being ejected.

Patent Document 3 (Japanese Laid-open Patent Publication No. 2005-52810) discloses a technique to clean an object according to a valence conversion method based on an oxidation and reduction colloid method by using pollutive substance-removing device. The technique includes a reduction cleaning step of peeling off pollutive substances from a silicon plate to remove the pollutive substances by dissolution, and makes use of the dissolving properties of gas and liquid colloids of hydrogen gas to prevent the pollutive substances from causing recontamination and utilizes an anti-bacteria effect to prevent microorganisms from recontaminating the already-cleaned silicon plate.

However, unlike the present invention, with regard to the technique disclosed by Patent Document 3, there is no description therein about that the flow-control means forms a predetermined flow in the washing fluid in the cleaning tank. Therefore, as in the case of Patent Document 2, it is impossible to cope with the problem that the increase in the quantity of the pollutive substances deteriorates the cleanliness of the washing fluid because when there is a large quantity of pollutive substances to be removed, the washing fluid accumulates e.g., in vicinities of cleaning targets and corners of the cleaning tank, which prevents the pollutive substances from being ejected.

Patent Document 4 (Japanese Laid-open Patent Publication No. 2004-154771) discloses a technique associated with an ultrasonic cleaning apparatus such that a cleaning target is immersed in a washing liquid with a horn member kept full of the washing liquid, and in this condition a cleaning work is carried out, during which the washing liquid in the horn member can be kept streaming, or can be kept accumulated, namely in a state of the solution impounded, and the streaming state and impounded state can be selected depending on the condition of the surface of a cleaning target.

However, unlike the present invention, with regard to the technique disclosed by Patent Document 4, there is no description therein about forming a predetermined flow in the washing fluid in the cleaning tank by use of a flow-control means. Therefore, similar to the case of each of Patent Documents 2 and 3 described above, it is impossible to cope with the problem that the increase in the quantity of the pollutive substances deteriorates the cleanliness of the washing fluid because when there is a large quantity of pollutive substances to be removed, the washing fluid accumulates e.g., in vicinities of cleaning targets and corners of the cleaning tank, which prevents the pollutive substances from being ejected.

The above-mentioned Patent Documents 1 to 4 are summarized in the following list.

(1) Patent Document 1: Japanese Laid-open Patent Publication No. 6-55151

(2) Patent Document 2: Japanese Laid-open Patent Publication No. 2006-231185

(3) Patent Document 3: Japanese Laid-open Patent Publication No. 2005-52810

(4) Patent Document 4: Japanese Laid-open Patent Publication No. 2004-154771

### SUMMARY OF THE INVENTION

The present invention has been conceived of in order to overcome the problem as described above. Therefore, it is an object of the invention to provide a cleaning apparatus, a cleaning tank, a cleaning method, and a computer-readable storage medium with a cleaning-control program stored therein, which can prevent reattachment of contaminants to a surface of a cleaning target when retrieving the cleaning target from the cleaning tank and realize high cleaning quality by efficiently ejecting contaminants floating in a washing fluid (e.g., washing liquid) to maintain the cleanliness of the washing fluid in the cleaning tank.

To attain the above object, a cleaning apparatus herein disclosed includes a flow-control unit generating a predetermined flow of a washing fluid (e.g., washing liquid) in a cleaning tank; and an ejection unit ejecting the washing fluid disposed on a flow path of the predetermined flow of the washing fluid. The cleaning apparatus is arranged so as to eject the washing fluid to the outside of the cleaning tank by using the ejection unit, when a cleaning target is set in the cleaning tank filled with the washing fluid, and the cleaning target is washed with the washing fluid to remove contaminants on a surface of the cleaning target.

It is preferable that in the cleaning apparatus, the flow-control unit generates the predetermined flow so that the washing fluid flows along a plurality of faces of the cleaning tank, respectively, and then collects together toward a center portion of the cleaning tank.

It is preferable that in the cleaning apparatus, the flow-control unit controls a supply direction or supply quantity of the washing fluid or a fluid different from the washing fluid, thereby to generate the predetermined flow in the washing fluid.

It is preferable that in the cleaning apparatus, the flow-control unit is placed near a supply hole for supplying the washing fluid into the cleaning tank so as to be opposed to the supply hole.

It is preferable that in the cleaning apparatus, the flow-control unit is placed near a supply hole for supplying the washing fluid into the cleaning tank so as to be opposed to the supply hole, and therein includes an ultrasonic vibrator arranged so as to be directed toward the cleaning target.

It is preferable that in the cleaning apparatus, one of a heating source and a cooling source is provided in the cleaning tank, and the one source is used to control a local temperature of the washing fluid, whereby the predetermined flow is generated in the washing fluid.

It is preferable that the cleaning apparatus includes a contaminant-detecting unit detecting a quantity of contaminants contained in the ejected washing fluid. The Contaminant-detecting unit controls supply and discharge quantities of the washing fluid according the detected contaminant quantity.

Further, a cleaning tank herein disclosed includes a flow-control unit forming a predetermined flow of a washing fluid; and an ejection unit ejecting the washing fluid disposed on a flow path of the predetermined flow of the washing fluid. The cleaning tank is arranged so as to eject the washing fluid to the outside of the cleaning tank by using the ejection unit, when a cleaning target is set in the cleaning tank filled with the washing fluid, and the cleaning target is washed with the washing fluid to remove contaminants on a surface of the cleaning target.

It is preferable that in the cleaning tank, the flow-control unit generates the predetermined flow so that the washing fluid flows along a plurality of faces of the cleaning tank, respectively, and then collects together towards a center portion of the cleaning tank.

Further, a cleaning method herein disclosed is directed to removing contaminants on a surface of a cleaning target set in a cleaning tank filled with a washing fluid by washing the cleaning target with the washing fluid, and includes generating a predetermined flow of the washing fluid in the cleaning tank by using a flow-control unit; disposing the cleaning target and an ejection unit for ejecting the washing fluid on a flow path of the predetermined flow of the washing fluid; and ejecting the washing fluid to outside the cleaning tank by using the ejection unit.

Also, the invention herein disclosed provides a computer-readable storage medium with a cleaning-control program stored therein for carrying out cleaning control for removing contaminants on a surface of a cleaning target set in a cleaning tank filled with a washing fluid by washing the cleaning target with the washing fluid, the program causing a computer to execute generating a predetermined flow of the washing fluid in the cleaning tank by using a flow-control unit; disposing the cleaning target and an ejection unit for ejecting the washing fluid on a flow path of the predetermined flow of the washing fluid; and ejecting the washing fluid to outside the cleaning tank by using the ejection unit.

In summary, first, with regard to a cleaning apparatus, a cleaning tank and a cleaning method herein disclosed, contaminants floating in a washing fluid can be ejected efficiently by controlling a flow of the washing fluid in the cleaning tank and ejecting the washing fluid therefrom. Thus, it becomes possible to maintain the cleanliness of the washing fluid in the cleaning tank and reattachment of contaminants to a surface of a cleaning target is prevented when retrieving the cleaning target from inside the cleaning tank is prevented. Therefore, the quality of cleaning can be enhanced remarkably.

Second, with regard to the cleaning apparatus, cleaning tank and cleaning method, the cleanliness of the washing fluid in the cleaning tank can be monitored quantitatively, and therefore a stable cleaning quality can be achieved. In addition, as it is also possible to grasp the progress of cleaning of a cleaning target, the cleaning time can be optimized.

### BRIEF DESCRIPTION OF THE DRAWINGS

The above object and features of the present invention will be more apparent from the following description of some preferred embodiments with reference to the accompanying drawings, wherein:

FIG. 1 is a lateral view of a cleaning tank for explaining a conventional cleaning method;

FIG. 2 is a lateral view showing a structure of a cleaning apparatus according to a basic embodiment of the invention;

FIG. 3 is a lateral view showing a structure of the whole cleaning apparatus according to a concrete embodiment of the invention;

FIG. 4 is a set of top and lateral views showing, in detail, a structure of the cleaning tank shown in FIG. 3;

FIG. 5 is a lateral view showing a first modification of the flow-control unit shown in FIG. 2;

FIG. 6 is a lateral view showing a second modification of the flow-control unit shown in FIG. 2;

FIG. 7 is a lateral view showing a third modification of the flow-control unit shown in FIG. 2;

FIG. 8 is a lateral view showing a fourth modification of the flow-control unit shown in FIG. 2;

FIG. 9 is a lateral view showing a fifth modification of the flow-control unit shown in FIG. 2;

FIG. 10 is a lateral view showing a sixth modification of the flow-control unit shown in FIG. 2;

FIG. 11 is a block diagram showing the connection between the cleaning apparatus shown in FIG. 2 and a personal computer;

FIG. 12 is a flow chart for explaining a control flow of the cleaning tank according to the embodiment;

FIG. 13 is a schematic diagram showing a contaminant-control model for the cleaning tank according to the embodiment; and

FIG. 14 is a graph showing examples of changes in the quantity of contaminants in the washing liquid in the cases of a conventional cleaning method and the cleaning method according to the embodiment.

### DESCRIPTION OF THE PREFERRED EMBODIMENTS

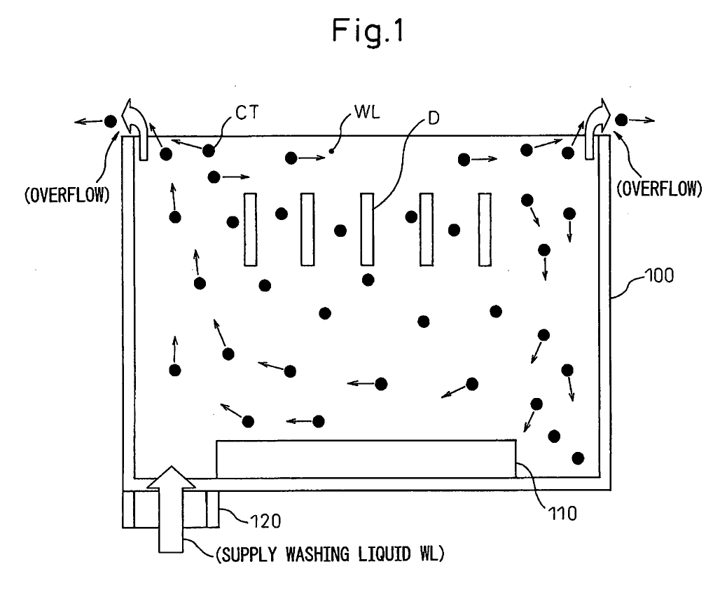

First, a conventional cleaning method and its problems will be described with reference to FIG. 1 before describing a cleaning apparatus, a cleaning tank and a cleaning method according to embodiments of the invention.

FIG. 1 is a lateral view of a cleaning tank for explaining a conventional cleaning method. As shown in FIG. 1, in the conventional cleaning method, a cleaning target D, such as a small-size device, is immersed in a washing liquid (or washing fluid) WL in a cleaning tank 100, and in this condition, ultrasonic waves are applied to the washing liquid WL by using an ultrasonic vibrator 110. Then, a contaminant (or contamination) CT on a surface of the cleaning target D is peeled off through a cavitation phenomenon. The washing liquid WL is supplied into the cleaning tank 100 through the supply hole 120 constantly, and the contaminant peeled off from the cleaning target is carried by the washing liquid flowing over the top face of the cleaning tank, and ejected to outside the tank together with the washing liquid.

However, the conventional cleaning method as described with reference to FIG. 1 causes the problem in that a washing liquid accumulates e.g., in vicinities of cleaning targets, and corner portions of a cleaning tank, which prevents the contaminants from being ejected, and increases the quantity of contaminants in the washing liquid and therefore deteriorates the cleanliness of the washing liquid. As a result of deterioration in the cleanliness of the washing liquid in the cleaning tank, contaminants peeled off from cleaning targets will adhere to the surfaces of the cleaning targets again, which will bring a disadvantage in that the quality of cleaning is degraded when the cleaning targets such as small-size devices are retrieved from inside the cleaning tank.

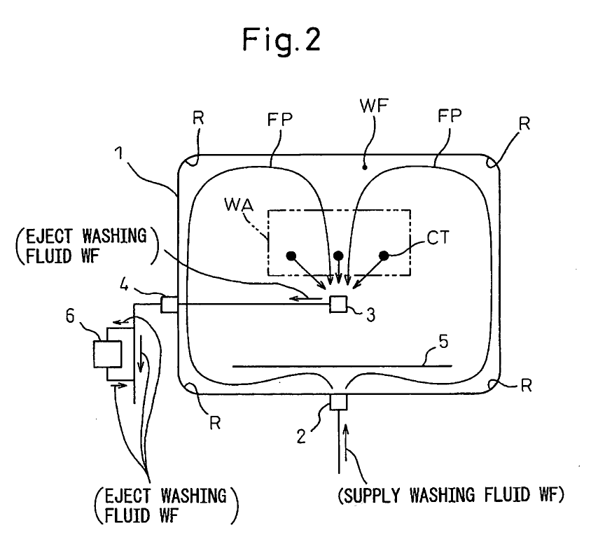

Now, a cleaning apparatus, a cleaning tank and a cleaning method according to embodiments of the invention, which are presented to overcome the disadvantage as described above, will be described with reference to FIGS. 2 to 14.

FIG. 2 is a lateral view showing a structure of a cleaning apparatus according to a basic embodiment of the invention, in which the simplified constituents of the cleaning apparatus are shown. Now, it is noted that the components identical to those described above are hereinafter identified by the same reference numerals or characters.

In the cleaning apparatus according to the basic embodiment shown in FIG. 2, the cleaning tank 1 filled with a washing fluid (e.g., washing liquid) WF includes a supply hole 2 for supplying the washing fluid WF, and an ejection hole 4 connected to an ejection means 3. Further, on a flow path FP, through which a predetermined flow of the washing fluid WF generated by a flow-control means 5 runs, a washing area WA for a cleaning target D (e.g., a small-size device) is laid out. The cleaning tank has a structure so that the washing fluid WF cannot accumulate e.g., in corners thereof, and bonding portions of faces of the cleaning tank 1 each take on a curved surface R.

Also, the flow-control means 5 in the cleaning tank 1 is laid out in the vicinity of the supply hole 2 to be opposed to the supply hole 2. The flow-control means 5 generates a flow in a center portion of the cleaning tank 1. The washing fluid WF flows together with the flow after flowing along the faces of the cleaning tank 1. The members constituting the flow-control means 5 are structured so that the washing fluid cannot be accumulated, and their peripheral portions take on a curved surface (not shown in FIG. 2).

The ejection means 3 included in the cleaning tank 1 is laid out on the flow path FP of the predetermined flow of the washing fluid WF. The ejection means has a structure for discharging the washing fluid to the outside of the cleaning tank. The members constituting the ejection means are structured so that the washing fluid cannot be accumulated, and their peripheral portions take on a curved surface (not shown in FIG. 2).

Also, the cleaning apparatus includes a contaminant-detecting means 6 for detecting (or measuring) the quantity of contaminants CT contained in the washing fluid, which the ejection means 3 has ejected to the outside of the cleaning tank 1. The contaminant-detecting means 6 controls the supply quantity of the washing fluid WF and the discharge quantity thereof according to the detected quantity of contaminants CT.

When the flow-control means 5, ejection means 3 and contaminant-detecting means 6 arranged as shown in FIG. 2 are used to control the flow of the washing fluid WF in the cleaning tank and discharge contaminants CT floating in the washing fluid efficiently, it becomes possible to maintain the cleanliness of the washing fluid WF in the cleaning tank.

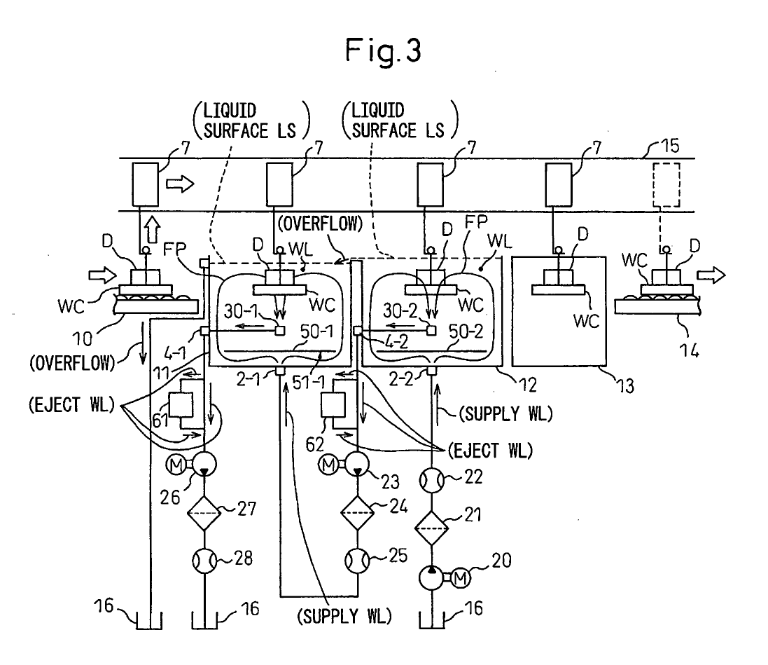

FIG. 3 is a lateral view showing a structure of the whole cleaning apparatus according to a concrete embodiment of the invention, in which the structure of a principal portion of the whole cleaning apparatus according to the concrete embodiment of the invention is shown in outline.

The cleaning apparatus shown in FIG. 3 includes a loader 10 for automatically supplying a cleaning target D such as a small-size device; an ultrasonic cleaning tank 11 for cleaning the cleaning target D by ultrasonic waves; a rinse-cleaning tank 12 for rinsing the cleaning target D after ultrasonic cleaning; a dry tank 13 for drying the cleaning target D after the cleaning in the ultrasonic cleaning tank 11 and rinse-cleaning tank 12; an unloader 14 for automatically unloading the cleaning target D; a transport mechanism 15 for transporting the cleaning target D to the individual tanks, i.e. the ultrasonic cleaning tank 11, rinse-cleaning tank 12 and dry tank 13, and the unloader 14 by means of manipulation of hand members 7; and a washing liquid tank 16 for holding the washing fluid WF.

The hand members 7 are provided in locations corresponding to the ultrasonic cleaning tank 11, rinse-leaning tank 12 and dry tank 13, and the unloader 14, respectively. The cleaning apparatus has a structure so that hand members 7 can be operated in parallel. However, the number of the hand members provided in the apparatus may be just one. The washing fluid WF used according to this embodiment consists of e.g., purified water. As for each of the ultrasonic cleaning tank 11 and the rinse-cleaning tank 12, a plurality of such tanks may be prepared.

In the embodiment shown in FIG. 3, the ultrasonic cleaning tank 11 has a flow-control plate 50-1 near a supply hole 2-1 for the washing liquid WL as the flow-control means laid out on the flow path FP of a flow of the washing liquid WL, and it has an ejection nozzle 30-1 and an ejection hole 4-1 as the ejection means. The rinse-cleaning tank 12 has a flow-control plate 30-2 near a supply hole 2-2 for the washing liquid WL as the flow-control means, and it has an ejection nozzle 30-2 and an ejection hole 4-2 as the ejection means. The flow-control plate 50-1 of the ultrasonic cleaning tank 11 has an ultrasonic vibrator 51-1 provided therein. The ejection nozzles 30-1 and 30-2 attenuate ultrasonic waves located above them, and thus the effect of cleaning by means of ultrasonic waves is reduced. Therefore, it is desired to set a cleaning target D in locations other than the places directly above the ejection nozzles 30-1 and 30-2.

The top face of the cleaning tank (or the liquid surface LS) is open for setting and retrieving a cleaning target D. The washing liquid in the washing liquid tank 16 is made to pass through a supply pump 20 and a supply filter 21 and then supplied to the rinse-cleaning tank 12 constantly. The washing liquid WL discharged through an ejection nozzle 30-2 of the rinse-cleaning tank 12 is made to pass through an in-liquid particle counter (LPC) 62, an ejector pump 23 and an ejection filter 24, which are contaminant-detecting means, and then supplied to the ultrasonic cleaning tank 11 constantly. On the other hand, the washing liquid WL having overflowed over the top face of the rinse-cleaning tank 12 is supplied to the ultrasonic cleaning tank 11. The washing liquid WL discharged through the ejection nozzle 30-1 of the ultrasonic cleaning tank 11 is made to pass through an in-liquid particle counter 61, an ejector pump 26 and an ejection filter 27, and then retrieved by the washing liquid tank 16.

The washing liquid having overflowed over the top face of the ultrasonic cleaning tank is retrieved by the washing liquid tank 16. In general, an overflow of the washing liquid is smaller in quantity than a discharge thereof. Therefore, no in-liquid particle counter is provided in or near a place in which the washing liquid overflows the tanks.

While the three washing liquid tanks 16 are illustrated in the drawing, the three tanks may be shared or provided as separate structures individually. Now, it is noted that flow-rate sensors 22, 25 and 28 for monitoring the supply and discharge quantities of the washing liquid are provided on the respective flow paths.

In the embodiment shown in FIG. 3, the cleaning target D is set in a washing case WC and conveyed to the cleaning apparatus. The washing case WC is grasped by the given hand member 7 of the transport mechanism 15 and transferred into the subsequent tank or unloader 14. In the dry tank 13, the washing liquid WL having adhered to a surface of the cleaning target D is dried by means of vepor drying or air-blow drying.

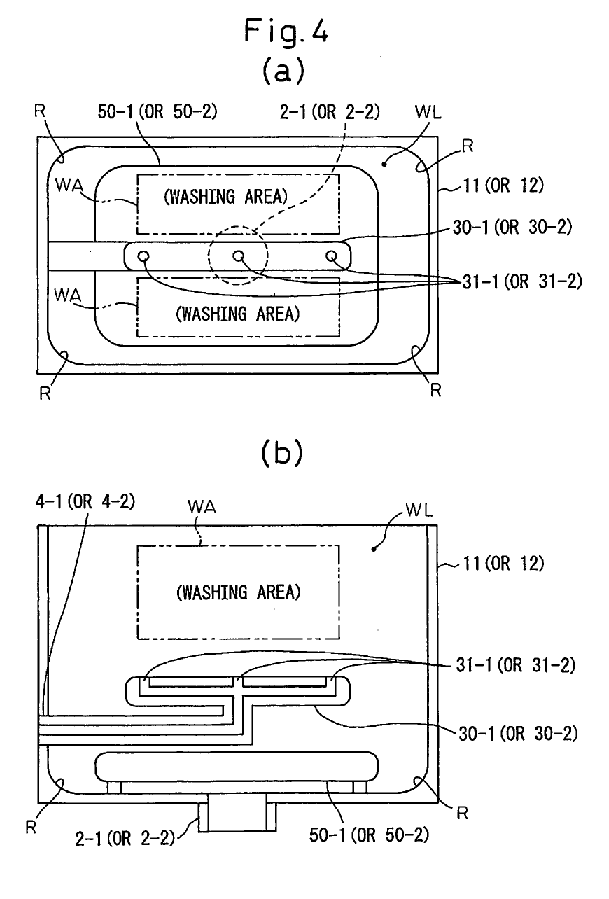

FIG. 4 is a set of top and lateral views showing, in detail, a structure of the cleaning tank shown in FIG. 3. More specifically, the portion (a) of FIG. 4 represents a top view of the cleaning tank as shown in FIG. 3, and the portion (b) of FIG. 4 represents a lateral view of the cleaning tank.

In the embodiment shown in FIG. 4, a supply hole 2-1 for the washing liquid WL is provided in a central portion of a bottom part of the ultrasonic cleaning tank 11, and an ejection hole 4-1 for the washing liquid WL is provided in a side part of the tank. Bonding portions of faces of the ultrasonic cleaning tank 11 each take on a curved surface R to prevent the washing liquid WL from being accumulated. On the other hand, a supply hole 2-2 for the washing liquid is provided in a central portion of the bottom part of the rinse-cleaning tank 12, and an ejection hole 4-2 for the washing liquid WL is provided in a side part thereof. Bonding portions of faces of the rinse-cleaning tank 12 each take on a curved surface to prevent the washing liquid WL from being accumulated.

Further, in the embodiment of FIG. 4, the flow-control plate 50-1 is provided over the supply hole 2-1 of the ultrasonic cleaning tank 11. A side part of the flow-control plate 50-1 and an inner face of the ultrasonic cleaning tank 11 are set to be spaced apart from each other by a predetermined distance. A peripheral portion of the flow-control plate 50-1 takes on a curved surface to prevent the washing liquid WL from being accumulated. On the other hand, the flow-control plate 50-2 is placed over a supply hole 2-2 of the rinse-cleaning tank 12. A side part of the flow-control plate 50-2 and an inner face of the rinse-cleaning tank 12 are set to be spaced apart from each other by a predetermined distance. A peripheral portion of the flow-control plate 50-2 takes on a curved surface to prevent the washing liquid WL from being accumulated.

Further, in the embodiment of FIG. 4, the ejection nozzle 30-1 in the ultrasonic cleaning tank 11 takes on a cylindrical form, and is placed between the flow-control plate 50-1 and the washing area WA for a cleaning target with the axis of the cylindrical form retained horizontally. In a top face of the cylindrical surface of the ejection nozzle 30-1, ejection holes 31-1 are provided as openings. The ejection holes 31-1 are linked together inside the ejection nozzle, and connected to an ejection hole 2-1 in the side face of the cleaning tank and a fluid pump (ejector pump). The number of ejection holes 31-1 is three, for example. As a result of the action of the fluid pump, the washing liquid WL is discharged to the outside of the cleaning tank through the ejection holes 31-1.

On the other hand, the ejection nozzle 30-2 in the rinse-cleaning tank 12 also takes on a cylindrical form, and is placed between the flow-control plate 50-2 and the washing area WA for a cleaning target with the axis of the cylindrical form retained horizontally. In a top face of the cylindrical surface of the ejection nozzle 30-2, ejection holes 31-2 are provided as openings. The ejection holes 31-2 are linked together inside the ejection nozzle, and connected to an ejection hole 2-2 in the side face of the cleaning tank and a fluid pump (ejector pump). As a result of the action of the fluid pump, the washing liquid WL is discharged to the outside of the cleaning tank through the ejection holes 31-2.

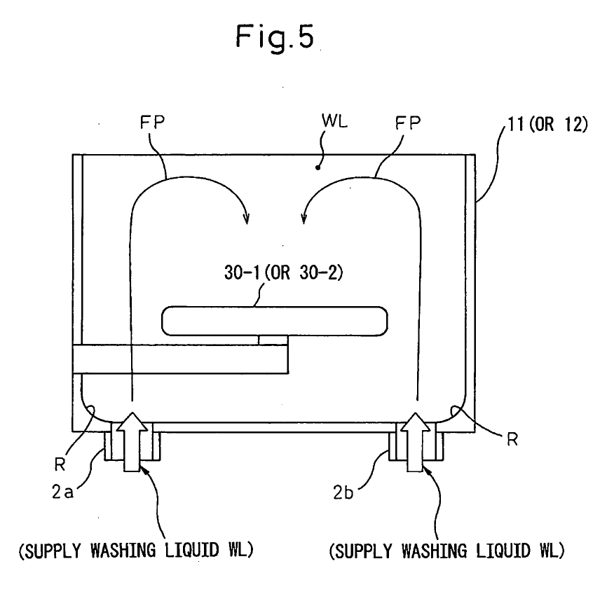

FIG. 5 is a lateral view showing a first modification of the flow-control means shown in FIG. 2. Here, instead of providing a flow-control plate as a flow-control means associated with the embodiment of FIG. 2, supply holes 2a and 2b are disposed on the periphery of the bottom part of each of the ultrasonic cleaning tank 11 and rinse-cleaning tank 12. As the washing liquid WL is supplied through the supply hole 2a and supply hole 2b, respectively, it is possible to bilaterally equally form a flow path FP of a flow of the washing liquid WL toward the ejection nozzle 30-1 (or 30-2).

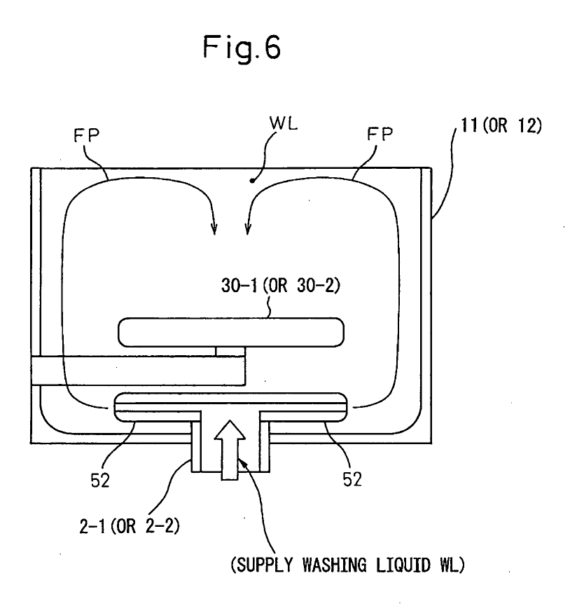

FIG. 6 is a lateral view showing a second modification of the flow-control means shown in FIG. 2. Here, instead of providing a flow-control plate as a flow-control means associated with the embodiment of FIG. 2, a radial nozzle 52 is mounted with respect to the supply hole 2-1 (or 2-2) of each of the ultrasonic cleaning tank 11 and rinse-cleaning tank 12. By using the radial nozzle 52 to supply the washing liquid WL, it can be also made possible to form a flow path FP of a flow toward the ejection nozzle 30-1 (or 30-2).

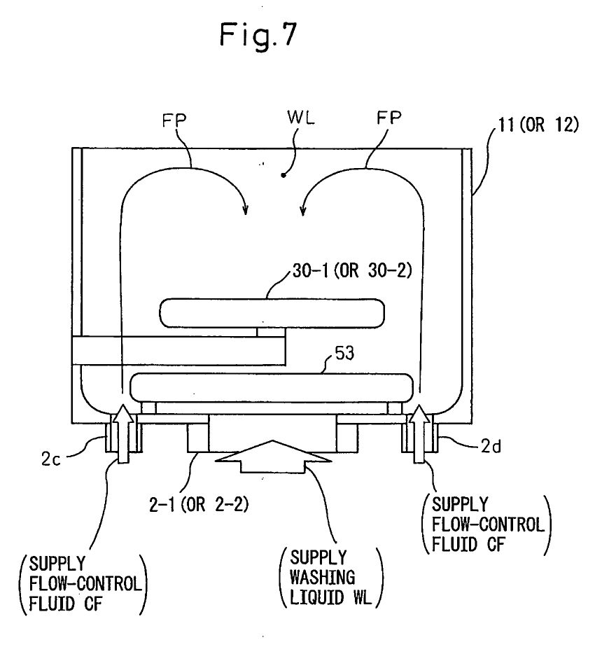

FIG. 7 is a lateral view showing a third modification of the flow-control means shown in FIG. 2. Here, the washing liquid WL is supplied through a supply hole 2-1 (or 2-2), and in parallel, another washing fluid such as air different from the washing liquid WL (e.g., a flow-control fluid CF) is supplied through other supply holes 2c and 2d.

As stated above, when using another washing fluid different from the washing liquid WL to control the supply direction of the washing liquid WL or the quantity of supply thereof, it is possible to form a flow path FP of a flow toward the ejection nozzle 30-1 (or 30-2). Herein, the direction and layout of the supply holes and ejection nozzles may be changed depending on the form of a cleaning target. In the case of controlling a flow of a washing fluid different from the washing liquid WL, supply of the washing liquid WL can interfere with the flow. Therefore, it is desired to widen the supply hole 2-1 (or 2-2) for the washing liquid WL or to mount a member for blocking the flow from the supply hole 2-1 (or 2-2) (e.g., a blocking plate 53).

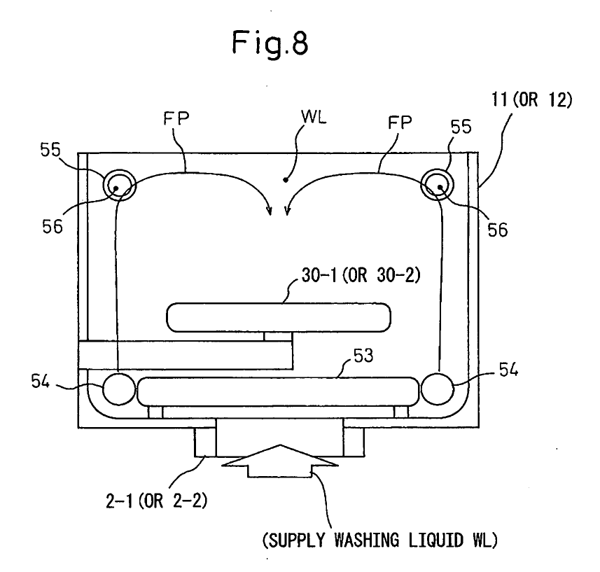

FIG. 8 is a lateral view showing a fourth modification of the flow-control means shown in FIG. 2. Here, the flow of the washing liquid WL is controlled by disposing a heating source 54, such as a heater, or a cooling source 55 utilizing a cooling water 56 on a flow path FP in the cleaning tank instead of controlling the supply direction of the liquid WL to be supplied.

Further elaborating, in the modification of FIG. 8, the heating source 54 or cooling source 55 is used to control a local temperature of the washing liquid WL, whereby a flow path FP of a flow of the washing liquid WL toward the ejection nozzle 30-1 (or 30-2) is formed. Also, in this case, similar to the case of FIG. 7 described above, it is desirable to widen the supply hole 2-1 (or 2-2) for the washing liquid WL or to mount a member for blocking the flow from the supply hole 2-1 (or 2-2) (e.g., a blocking plate 53).

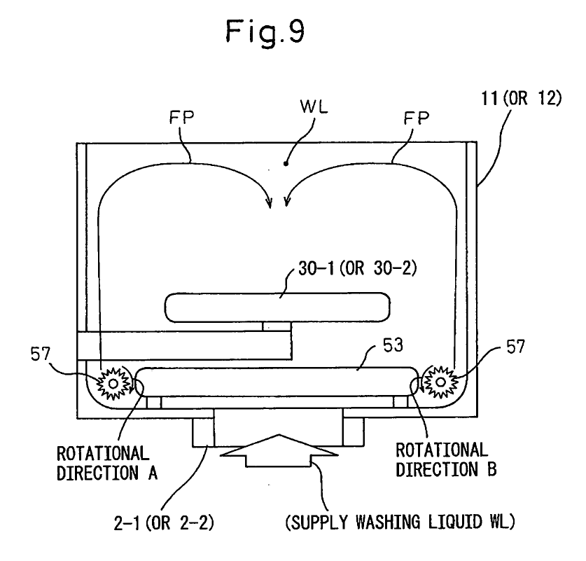

FIG. 9 is a lateral view showing a fifth modification of the flow-control means shown in FIG. 2. Here, the flow of the washing liquid WL is controlled by disposing a mechanical system, such as a screw 57, on a flow path FP in the cleaning tank instead of controlling the supply direction of the liquid WL to be supplied.

Further elaborating, in the modification of FIG. 9, each of a pair of screws 57 or the like is rotated in the rotational direction A or rotational direction B (which is reverse to the direction A), whereby a flow path FP of a flow of the washing liquid WL toward the ejection nozzle 30-1 (or 30-2) is formed. Also, in this case, as in the case of FIG. 8 described above, it is desired to widen the supply hole 2-1 (or 2-2) for the washing liquid WL or to mount a member for blocking the flow from the supply hole 2-1 (or 2-2) (e.g., a blocking plate 53).

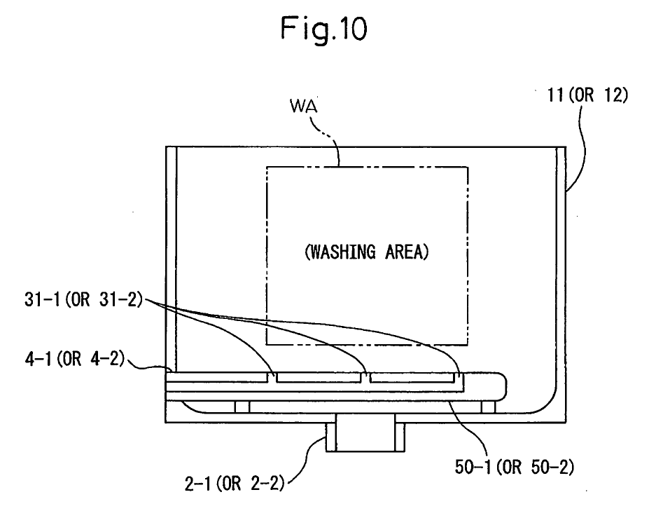

FIG. 10 is a lateral view showing a sixth modification of the flow-control means shown in FIG. 2. Here, an ejection nozzle with two or more ejection holes 31-1 (or 31-2) formed therein is embedded in a flow-control plate 50-1 (or 50-2) over the supply hole 2-1 (or 2-2) for the washing liquid instead of being mounted between the flow-control plate 50-1 and the washing area WA for a cleaning target. In this case, as it is not necessary to provide the flow-control plate and ejection nozzle separately, the structure inside the cleaning tank is simplified, and therefore the washing area WA can be made larger. Moreover, the flow-control plate 50-1 (or 50-2) may contain an ultrasonic vibrator.

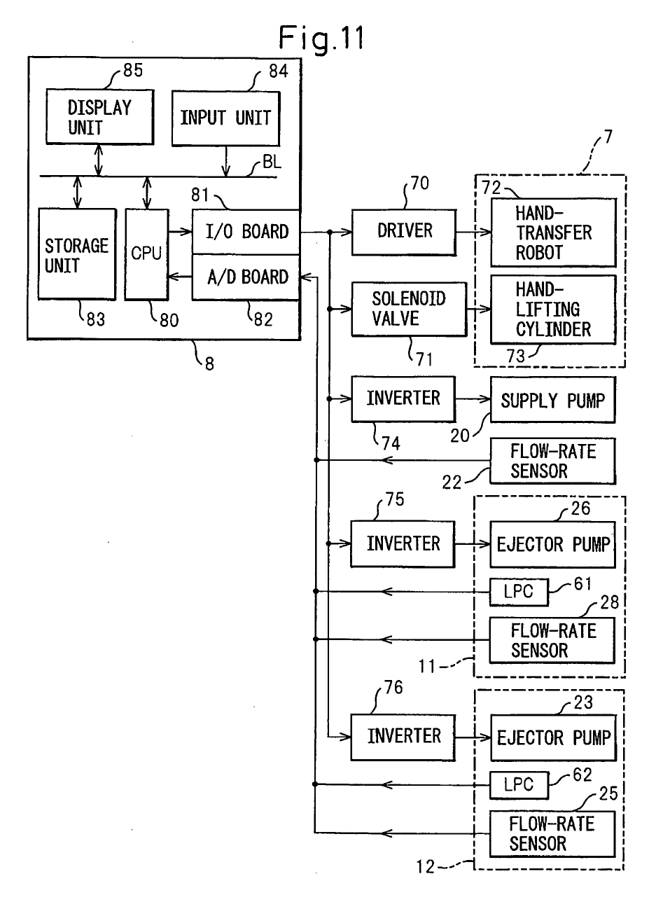

FIG. 11 is a block diagram showing the connection of the cleaning apparatus according to the embodiment shown in FIG. 2 with a personal computer. Here is exemplified a wiring diagram which shows the connections of the respective constituents including the ultrasonic cleaning tank 11, rinse-cleaning tank 12 and transport mechanism 7 of the embodiment shown in FIG. 2 with a multipurpose personal computer 8 for controlling a flow of the washing liquid, however a sequencer may be used instead of the personal computer.

As in the block diagram of FIG. 11, the supply pump 20 of the rinse-cleaning tank 12, the ejector pump 26 of the ultrasonic cleaning tank 11, and the ejector pump 23 of the rinse-cleaning tank 12 are connected to an I/O (Input/Output) board 81 of the personal computer 8 through inverters 74, 75 and 76, respectively. Further, a hand-transfer robot 72 of the transport mechanism 7 is connected to the I/O board 81 through a driver 70. A hand-lifting cylinder 73 of the transport mechanism 7 is connected to the I/O board 81 through a solenoid valve 71. Moreover, the flow-rate sensors 22, 25 and 28 and in-liquid particle counters (LPC) 61 and 62 are connected to an A/D (Analog/Digital) board 82 of the personal computer 8.

However, the personal computer 8 also includes a CPU 80 which processes data input through the A/D (Analog/Digital) board 82, and data entered by a user or the like operating an input unit 84; a storage unit (memory) 83 for storing various kinds of data including a (software) program for executing the cleaning method according to the embodiment; and a display unit 85 for displaying data entered as a result of an operation of the input unit 84, and how the cleaning method according to the embodiment is executed. The CPU 80, storage unit 83, input unit 84 and display unit 85 are connected through a bus BL mutually. While the storage unit 83 is composed of a ROM (Read-only Memory), RAM (Random Access Memory) or the like, a ROM or RAM incorporated in the CPU 80 may be used instead of the storage unit 83.

In the embodiment shown by FIG. 11, the CPU 80 of the personal computer 8 is used to control the quantities of evacuation of the supply and ejector pumps, and the operation timings of the hand-transfer robot 72 and hand-lifting cylinder 73 of the given hand member 7 according to signals from the in-liquid particle counters (LPC) 61 and 62. The quantities of evacuation of the supply and ejector pumps are monitored by the flow-rate sensors 22, 25 and 28 at all times.

It is preferable that in the cleaning method according to this embodiment, the function of controlling a flow of the washing liquid is realized by the CPU 80 as shown in FIG. 11. More specifically, the CPU 80 reads out a program for executing the cleaning method, which is stored in e.g., ROM of the storage unit 83 as shown in FIG. 11, and various kinds of data stored in RAM or the like, which are required for execution of the program to run the program, whereby the functions of controlling the quantities of evacuation of the supply and ejector pumps, and the functions of controlling the operation timings of the hand-transfer robot and hand-lifting cylinder are realized by the CPU 80 (the software program).

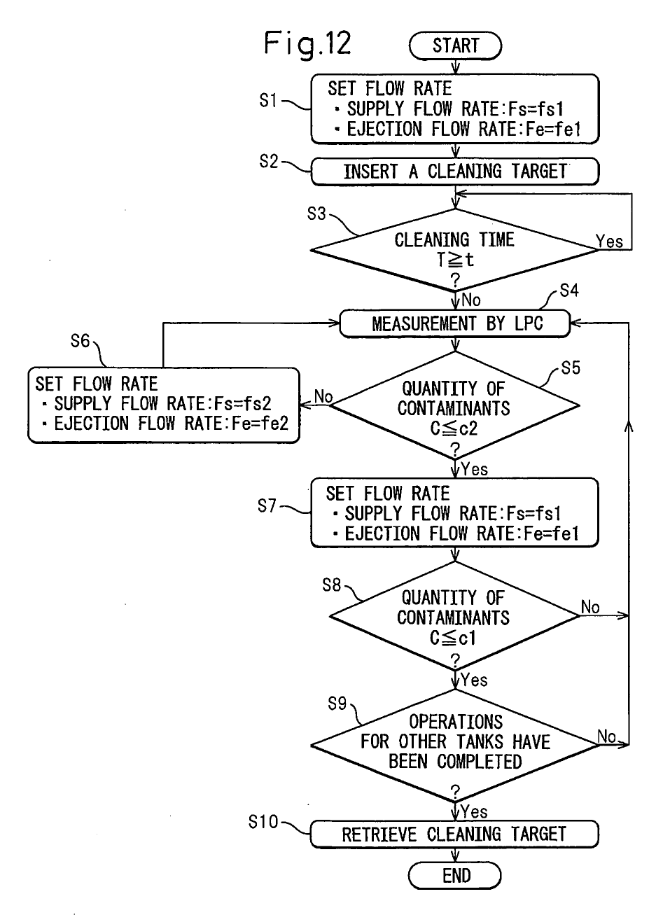

FIG. 12 is a flow chart for explaining the control flow of the cleaning tank according to the embodiment of the invention. Here is shown a process flow of the program for controlling the supply quantity of the washing liquid to and the discharge quantity thereof from each cleaning tank, which works on the CPU of the personal computer.

As in the flow chart of FIG. 12, in Step S1, the flow-rate sensor is used to check that the supply flow rate Fs and the ejection flow rate Fe are predetermined set values fs1 and fe1, respectively. Subsequently, as shown in Step S2, a cleaning target is inserted in the cleaning tank, and then cleaning is started.

Further, in Steps S3, it is judged whether or not a predetermined length of time T has elapsed (the elapsed time t has changed in condition from T≧t to T<t). When T<t holds, the quantity of contaminants C in the washing liquid is measured by the in-liquid particle counter (LPC), as shown in Step S4. When it is judged, in Step S5, that the quantity of contaminants C satisfies the condition c2≧C>c1, the process execution proceeds to Step S7, and the cleaning is continued with the flow rate kept unchanged. However, when it is judged, in Step S5, that the quantity of contaminants C satisfies the condition C>c2, the process execution proceeds to Step S6, and the supply flow rate Fs and the ejection flow rate Fe are changed to fs2 and fe2, respectively.

Further, in Step S8, at the time when the quantity of contaminants C is brought into a condition such that C≦c1 holds, it is checked that the supply flow rate Fs and the ejection flow rate Fe are fs1 and fe1, respectively. In Step S9, the program waits for the completion of operations associated with the other tanks.

After operations associated with all the other tanks have been finished, in Step S10, the cleaning target is retrieved, and then transferred to the subsequent tank or unloader. Incidentally, the following relations hold among the set values: fs1<fs2, fe1<fe2, fs1>fe1, fs2>fe2, and cl<c2. In addition, in control of the supply flow rate and the ejection flow rate, the set values of the downmost tank have top priority.

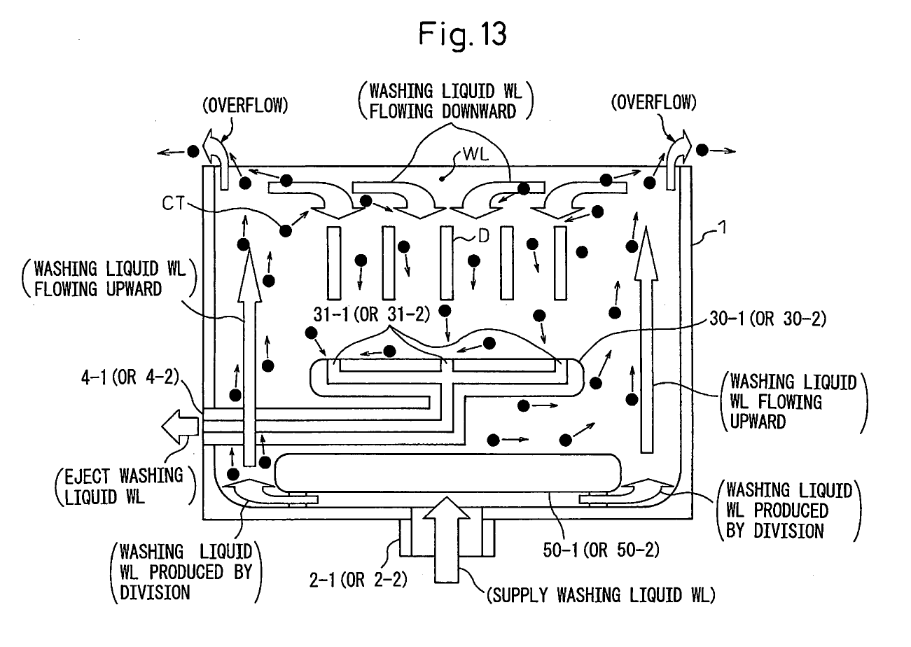

FIG. 13 is a schematic diagram showing a contaminant-control model for the cleaning tank according to the embodiment of the invention.

In the control model as shown by FIG. 13, the washing liquid WL supplied through the supply hole 2-1 (or 2-2) impinges on the lower face of the flow-control plate 50-1 (or 50-2), and distributed in every direction. The washing liquid WL thus distributed flows upward along a side part of a cleaning tank 1 (e.g., the ultrasonic cleaning tank 11 or rinse-cleaning tank 12 as shown in FIG. 3). Then, part of the washing liquid WL overflows the tank, and the remaining part thereof forms a downward flow near the center of the cleaning tank 1. In the place toward which the downward streaming washing liquid flows, ejection holes 31-1 (or 31-2) of the ejection nozzle 30-1 (or 30-2) are located, and therefore a predetermined volume of the washing liquid WL is to be ejected to the outside of the cleaning tank. For example, in the case of the rinse-cleaning tank, the quantities of the washing liquid WL to be supplied, discharged and allowed to overflow are 12 L/min (liters per minute), 10 L/min and 2 L/min, respectively.

Further, in the control model as shown in FIG. 13, contaminants CT peeled off from a surface of each cleaning target D by the washing liquid are ejected through the ejection nozzle 31-1 (or 31-2) located right below. The contaminants which has not been ejected through the ejection nozzle and overflow, are carried on and by a flow created by the flow-control plate 50-1 (or 50-2), collected in a portion above the ejection nozzle 30-1 (or 30-2) again, and then ejected to the outside of the cleaning tank through the ejection hole 4-1 (or 4-2).

The number of contaminants contained in the washing liquid thus ejected is measured by an in-liquid particle counter (LPC), whereby the cleanliness of the washing liquid WL in the cleaning tank is monitored quantitatively. Thus, it becomes possible to grasp the progress of cleaning of the cleaning target. In addition, controlling the supply and discharge quantities of the washing liquid WL according to the measurements can shorten the cleaning time without deteriorating the quality of cleaning. Now, it is noted that pH (hydrogen ion concentration index) or viscosity of the washing liquid may be measured as a monitoring index of the cleanliness of the washing liquid by using an instrument such as a pH meter or an ultrasonic meter.

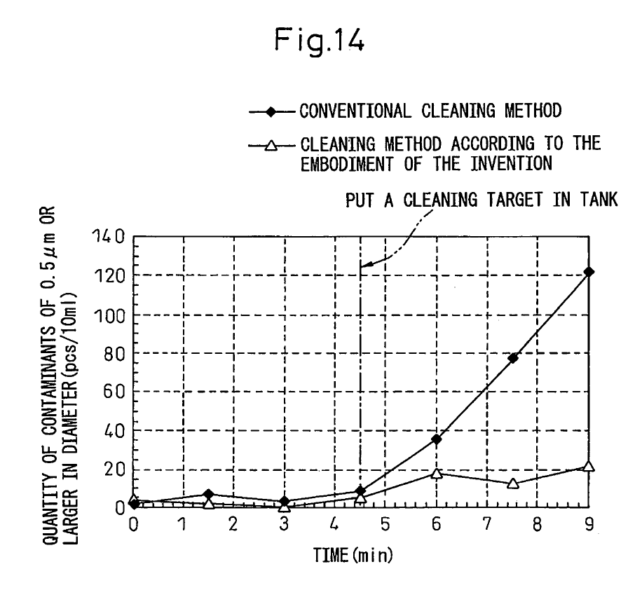

FIG. 14 is a graph showing examples of changes in the quantity of contaminants in the washing liquid in the case of each of a conventional cleaning method and the cleaning method according to the embodiment of the invention. Here are shown examples of changes in the quantity of contaminants in the washing liquid measured by using an in-liquid particle counter (LPC) in a rinse-cleaning tank of the last stage.

In the graph of FIG. 14, the cleaning target to be compared is a part used for a hard disk drive. As is clear from the graph of FIG. 14, in the case of the cleaning method according to the embodiment of the invention (the curve plotted with an unfilled triangle), the quantity of contaminants having a diameter of 0.5 μm or larger (in units of pcs/10 ml) at the time when a fixed length of time (in units of minutes) has elapsed after a cleaning target is put in the tank is controlled to or below one sixth the maximum in comparison to a conventional cleaning method, by which only an overflow is used, (the curve plotted with a filled diamond). Therefore, for the cleaning method according to the embodiment of the invention, it can be seen that the cleanliness of the washing liquid is maintained with stability at all times without sharply increasing the quantity of contaminants.

The cleaning apparatus according to the above-described embodiment is applicable to a device-cleaning apparatus which is required to assure a high cleaning quality when cleaning a device targeted for cleaning by using a washing fluid in a cleaning tank in a process for fabricating devices, such as a magnetic head of HDD, MEMS, and an optical part.

1. A cleaning apparatus for removing contaminants on a surface of a cleaning target set in a cleaning tank filled with a washing fluid by washing the cleaning target with the washing fluid, comprising:
a flow-control unit generating a predetermined flow of the washing fluid in the cleaning tank; and
an ejection unit ejecting the washing fluid disposed on a flow path of the predetermined flow of the washing fluid,
wherein the ejection unit is used to eject the washing fluid to outside the cleaning tank.

2. The cleaning apparatus of claim 1, wherein the flow-control unit generates the predetermined flow so that the washing fluid flows along a plurality of faces of the cleaning tank, respectively, and then collects together toward a center portion of the cleaning tank.

3. The cleaning apparatus of claim 1, wherein the flow-control unit controls a supply direction or supply quantity of the washing fluid or a fluid different from the washing fluid, thereby to generate the predetermined flow in the washing fluid.

4. The cleaning apparatus of claim 1, wherein the flow-control unit is placed near a supply hole for supplying the washing fluid into the cleaning tank so as to be opposed to the supply hole.

5. The cleaning apparatus of claim 1, wherein the flow-control unit is placed near a supply hole for supplying the washing fluid into the cleaning tank so as to be opposed to the supply hole, and therein includes an ultrasonic vibrator arranged so as to be directed toward the cleaning target.

6. The cleaning apparatus of claim 1, wherein one of a heating source and a cooling source is provided in the cleaning tank, and
the one source is used to control a local temperature of the washing fluid, whereby the predetermined flow is generated in the washing fluid.

7. The cleaning apparatus of claim 1, wherein a mechanical system unit is placed in the cleaning tank, and
the predetermined flow is generated by an operation of the mechanical system unit in the washing fluid.

8. The cleaning apparatus of claim 1, wherein the ejection unit includes an ejection nozzle having an opening in its top face,
the ejection nozzle is connected to a fluid pump, and
the washing fluid is ejected to outside the cleaning tank through the opening by an operation of the fluid pump.

9. The cleaning apparatus of claim 1, wherein each of peripheral portions of any members placed in tanks including the cleaning tank has a curved surface.

10. The cleaning apparatus of claim 1, further comprising
a contaminant-detecting unit detecting a quantity of contaminants contained in the ejected washing fluid,
wherein the contaminant-detecting unit controls supply and discharge quantities of the washing fluid according the detected contaminant quantity.

11. The cleaning apparatus of claim 2, wherein the flow-control unit controls a supply direction or supply quantity of the washing fluid or a fluid different from the washing fluid, thereby to generate the predetermined flow in the washing fluid.

12. A cleaning tank for removing contaminants on a surface of a cleaning target set therein by washing the cleaning target with the washing fluid when filled with a washing fluid, comprising:
a flow-control unit generating a predetermined flow of the washing fluid; and
an ejection unit ejecting the washing fluid disposed on a flow path of the predetermined flow of the washing fluid,
wherein the ejection unit is used to eject the washing fluid to outside the cleaning tank.

13. The cleaning tank of claim 12, wherein the flow-control unit generates the predetermined flow so that the washing fluid flows along a plurality of faces of the cleaning tank, respectively, and then collects together towards a center portion of the cleaning tank.

14. The cleaning tank of claim 12, wherein the flow-control unit controls a supply direction or supply quantity of the washing fluid or a fluid different from the washing fluid, thereby to generate the predetermined flow in the washing fluid.

15. The cleaning tank of claim 12, wherein the flow-control unit is placed near a supply hole for supplying the washing fluid into the cleaning tank so as to be opposed to the supply hole.

16. A cleaning method for removing contaminants on a surface of a cleaning target set in a cleaning tank filled with a washing fluid by washing the cleaning target with the washing fluid, comprising:
generating a predetermined flow of the washing fluid in the cleaning tank by using a flow-control unit;
disposing the cleaning target and an ejection unit for ejecting the washing fluid on a flow path of the predetermined flow of the washing fluid; and
ejecting the washing fluid to outside the cleaning tank by using the ejection unit.

17. The cleaning unit of claim 16, wherein the predetermined flow is generated in the washing fluid by controlling a supply direction or supply quantity of the washing fluid or a fluid different from the washing fluid.

18. The cleaning method of claim 16, comprising providing a contaminant-detecting unit for detecting a quantity of contaminants contained in the ejected washing fluid,
wherein the contaminant-detecting unit controls supply and discharge quantities of the washing fluid according the detected contaminant quantity.

19. A computer-readable storage medium having a cleaning-control program stored therein for carrying out cleaning control for removing contaminants on a surface of a cleaning target set in a cleaning tank filled with a washing fluid by washing the cleaning target with the washing fluid, the program causing a computer to execute:
generating a predetermined flow of the washing fluid in the cleaning tank by using a flow-control unit;
disposing the cleaning target and an ejection unit for ejecting the washing fluid on a flow path of the predetermined flow of the washing fluid; and
ejecting the washing fluid to outside the cleaning tank by using the ejection unit.
